(19) United States
(12) Patent Application Publication
(10) Pub. No.: US 2005/0281984 A1
(43) Pub. Date: Dec. 22, 2005

(54) Structural elements formed from castable material

(76) Inventor: Gerardus Maria Van Erp, Queensland (AU)

Correspondence Address: WORKMAN NYDEGGER;(F/K/A WORKMAN NYDEGGER & SEELEY), 60 EAST SOUTH TEMPLE, 1000 EAGLE GATE TOWER, SALT LAKE CITY, UT, 84111, US

(21) Appl. No.: 10/528,854

(22) PCT Filed: Sep. 25, 2003
(86) PCT No.: PCT/AU03/01269

§ 371 Date: Mar. 23, 2005

(30) Foreign Application Priority Data
Sep. 25, 2002 (AU) 2002951633
Nov. 13, 2002 (AU) 2002952659

(51) Int. Cl. B28B 1/16; B32B 1/08

(52) U.S. Cl. 428/166; 264/219; 264/275; 264/279; 264/279.1; 264/162; 264/129; 264/131; 428/188; 428/34.4

(57) ABSTRACT

A structural element formed from castable material, said structural element comprising: a plurality of fibre reinforced plastic, tubular members; a plurality of fibre reinforced plastic, spacer members, said spacer members extending between said plurality of tubular members; a plurality of fibre reinforced plastic, interconnecting members, said interconnecting members positioned in a different orientation to said spacing members; and castable material surrounding said members; wherein the interconnecting members and spacer members intersect with each other.

### FIELD OF THE INVENTION

This invention relates to structural elements formed from castable material. In particular, the invention relates to reinforcement of polymer concrete structural elements using fibre-reinforced plastics. However, it should be appreciated that other castable material such as standard concrete may be used to form the structural element.

### BACKGROUND OF THE INVENTION

Polymer concrete is made by polymerising a polymeric material with filler material such as aggregate (e.g. gravel, sand etc.). Polymer concrete has generally good durability and chemical resistance and is therefore used in various applications such as in pipes, tunnel supports, bridge decks and electrolytic containers. The compressive and tensile strength of polymer concrete is generally significantly higher than that of standard concrete. As a result polymer concrete structures are generally smaller and significantly lighter than equivalent structures made out of standard concrete.

However, polymer concrete still requires reinforcement as with standard concrete. This normally involves the use of traditional reinforcement bars that are placed with the concrete during the forming process. In corrosive environment traditional steel reinforcement is subject to corrosion and therefore has been increasingly replaced with fibre composite reinforcement.

The superior physical properties of fibre composites are well recognised. They combine high strength with low weight and have generally good durability and resistance to salts, acids and other corrosive materials, depending on the resin formulation. Based on these material characteristics, fibre composite reinforcement has a range of advantages over traditional steel reinforcement which is heavy and subject to corrosion. Fibre composite reinforcement for concrete and polymer concrete structures is available but generally has a form similar to traditional steel reinforcement. That is, different diameter, round bars and ligatures (stirrups).

This type of fibre composite reinforcement does not result in any significant material or weight saving over standard steel reinforcement. Furthermore, this standard fibre composite reinforcement is expensive and rather inflexible. The straight bars are extremely difficult to shape to include cogs or hooks at the ends to improve the anchorage. The ligatures are supplied as a prefabricated item and cannot be re-shaped or adjusted for different size or shape beams.

Reinforcement bars and ligatures were developed to be made of steel and used in standard concrete. As has been shown many times before, structural concepts developed for traditional materials are not necessarily the most efficient solution in fibre composites.

### OBJECT OF THE INVENTION

It is an object of the invention to overcome or alleviate one or more of the disadvantages of the above disadvantages or provide the consumer with a useful or commercial choice.

It is a preferred object of this invention to enable structural elements made from concrete with continuous fibre composite reinforcement to be produced that have improved load-carrying characteristics.

It is a further preferred object of the invention to allow structural elements made of concrete and continuous fibre composite reinforcement to be produced cost effectively.

It is a still further preferred object of the invention to allow structural elements made of concrete and continuous fibre composites reinforcement to be produced with a significantly reduced weight.

### SUMMARY OF THE INVENTION

In one form, although not necessarily the only or broadest form, the invention resides in a structural element formed from castable material, said structural element comprising:

a plurality of fibre reinforced plastic, tubular members;

a plurality of fibre reinforced plastic, spacer members, said spacer members extending between said plurality of tubular members;

a plurality of fibre reinforced plastic, interconnecting members, said interconnecting members positioned in a different orientation to said spacing members; and

castable material surrounding said members;

wherein the interconnecting members and spacer members intersect with each other.

The members may be produced from any suitable glass, carbon or aramid fibre and/or plastics material dependant upon the desired properties of the structural element. A surface area of the members that contact the castable material may be abraded to increase adhesion between the castable material and the members. Alternatively, the members may be coated with sand and/or gravel interface to increase adhesion.

The tubular members may be pultruded fibre reinforced plastic. Preferably, the tubular members are substantially square in transverse cross-section. The tubular members may be hollow to save maximum weight.

In another form, the tubular members may be filled with standard concrete, polymer concrete or a filled resin system to increase their load carrying capacity.

In yet another form, the tubular members may be filled with standard concrete, polymer concrete or a filled resin system and a metal or fibre composite reinforcing bar to further increase their load carrying capacity.

The spacer members and interconnecting members are usually constructed from the same fibre reinforced plastic. Preferably, the spacer member and interconnecting members are normally stronger than the transverse strength of the tubular members.

The interconnecting members may pass through the spacer members or the spacer members may pass through the interconnecting members or a combination of both.

Slots may be located in either or both of the interconnecting members and/or spacer members to allow the interconnecting members and spacer members to intersect.

The interconnecting members and spacer members may be locked to each other after they intersect. Notches may be provides in the interconnecting members and/or spacer members to engage with the slot on the other of the interconnecting member or spacer member to lock the interconnecting members and spacer members together.

Preferably the interconnecting members are oriented so that they are substantially perpendicular to the spacer members.

The castable material is usually concrete. Preferably, the concrete is polymer concrete or a filled resin system.

In another form, the invention resides in a method of producing a structural element formed from castable material, said method including the steps of:

producing a mould that has a portion of an outer shape of the structural element to be produced;

placing fibre reinforced plastic, tubular members; fibre reinforced plastic, spacer members; and fibre reinforced plastic, interconnecting members; within the mould such that said spacer members extending between said plurality of tubular members and said interconnecting members are positioned in a different orientation to said spacing members; so the spacing members and interconnecting members intersect;

locating castable material between and over said members;

allowing said castable material to set to form said structural element.

The members may be abraded prior to the members being introduced into the mould. Alternatively, the members may be coated with sand and/or gravel interface to increase adhesion.

In one embodiment, the members may be located within the mould and castable material poured over the members.

In another embodiment, the members may be located within the mould after sufficient castable material to complete the structural element has been delivered into the mould.

In still another embodiment, a portion of castable material may be introduced into the mould and some of the members introduced into the mould. More castable material may then be introduced into the mould and more members may be introduced into the mould. This may be continued until the structural element has been completed.

### BRIEF DESCRIPTION OF THE DRAWINGS

Embodiments of the invention, by way of example only, will be described with reference to the accompany drawings in which:

FIG. 1 is a perspective view of a structural element according to an embodiment of the invention;

FIG. 2 is a perspective view of a fibre reinforced plastic members according to FIG. 1;

FIG. 3 is a sectional side view of the structural element of FIG. 1.

FIG. 4 is a further sectional side view of the structural element of FIG. 3;

FIG. 5A is a first step in producing the structural element of FIG. 1;

FIG. 5B is a second step in producing the structural element of FIG. 1;

FIG. 5C is a third step in producing the structural element of FIG. 1;

FIG. 5D is a final step in producing the structural element of FIG. 1;

FIG. 6A is a perspective view of an interconnecting system between an interconnecting member and a spacer member;

FIG. 6B is a further perspective view of an interconnecting system between an interconnecting member and a spacer member;

FIG. 6C is a further perspective view of an interconnecting system between an interconnecting member and a spacer member;

FIG. 7 is a side view of a structural element according to a second embodiment of the invention;

FIG. 8 is a side view of a structural element according to a third embodiment of the invention;

FIG. 9 is a side view of a structural element according to a fourth embodiment of the invention; and

FIG. 10 is a perspective view of a structural member according to a fifth embodiment of the invention.

FIG. 11 shows a perspective view of a structural element according to a sixth embodiment of the invention.

### DETAILED DESCRIPTION OF THE PREFERRED EMBODIMENT

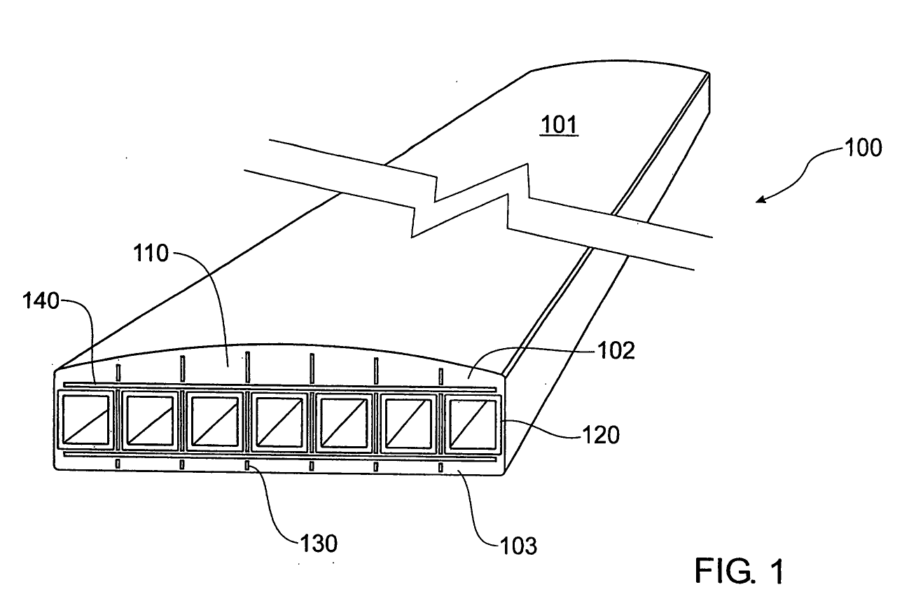

FIG. 1 shows a structural element 100 in the form of a marine beam 101. The marine beam 101 is produced using a polymer concrete 110 that is reinforced using fibre reinforced plastic tubular members 120; fibre reinforced plastic, spacer members 130; and fibre reinforced plastic, interconnecting members 140.

The tubular members 120 are square in transverse cross-section and are pultruded from polyester resin and glass fibre. The spacer members 130 and interconnecting members 140 are flat sheets that are produced from vinyl ester and carbon fibre.

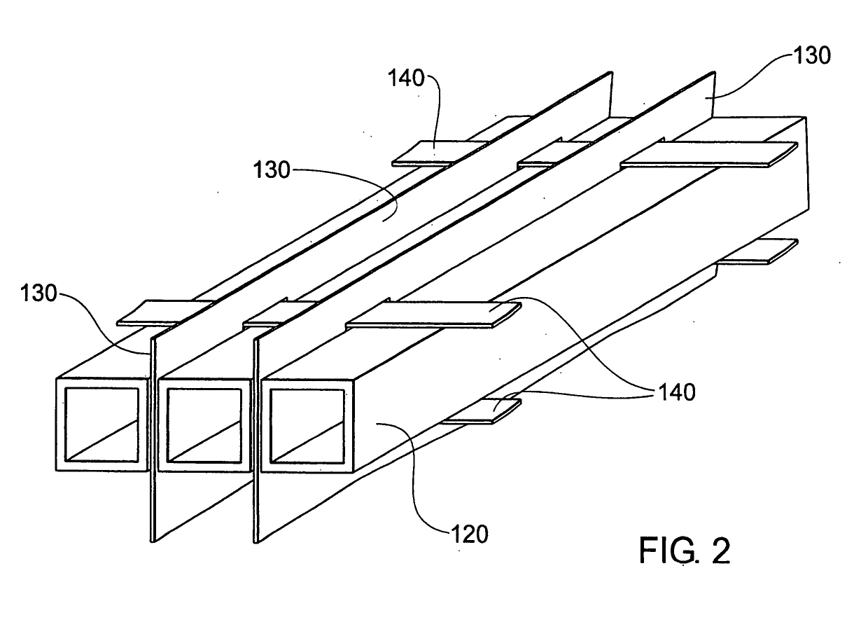

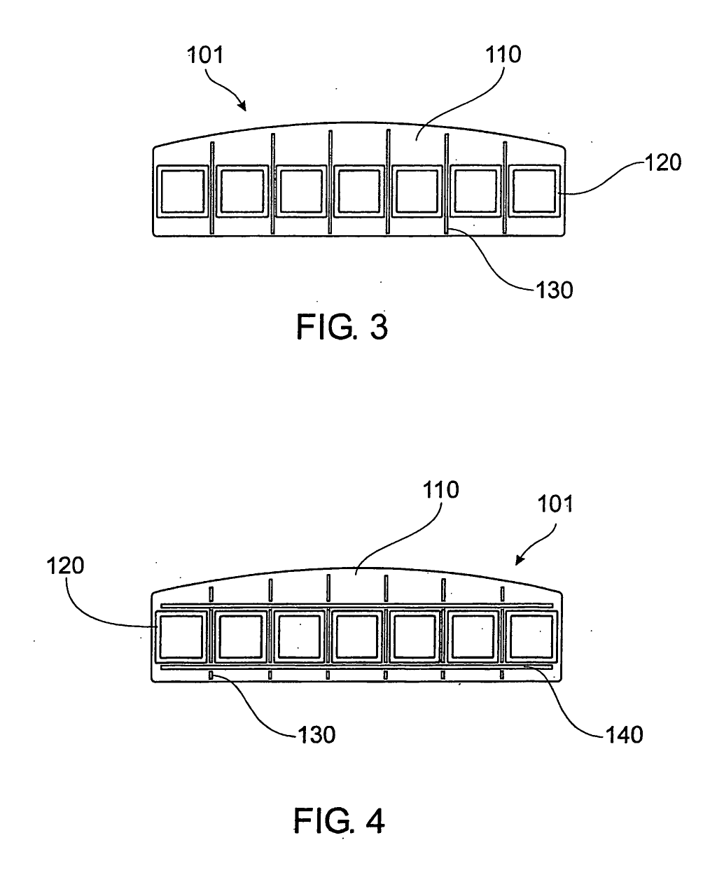

Referring also to FIGS. 2 to 4, the arrangement of the tubular members 120, space members 130 and interconnecting members 140 are shown in more detail. The tubular members 120 extend the length of the marine beam 101 with the spacer members 130 located between adjacent tubular members 140. Slots are located within the spacer members 130 so that the interconnecting members 140 can be placed through the spacer members 130. FIG. 4 shows a cross-section of the marine beam 101 that passes through the interconnecting members 140, whilst FIG. 3 shows a cross-sectional side view of the marine beam 101 that passes only through the spacer members 130.

It should be appreciated that the interconnecting members 140 are spaced along predetermined lengths of the marine beam 101. The spacing of the interconnecting members 140 along the spacer members 130 may be varied according to the structural requirements. That is, if increased lateral strength is required, the distances between adjacent interconnecting members 140 can be reduced.

The advantage of a construction of the marine beam 101 is that fibre dominated behaviour is exhibited in three dimensions. That is, increased strength is provided both longitudinally, laterally and transversely. Specifically, the tubular members 120 provide both longitudinal, lateral and transverse strength to the marine beam. The spacer members 130 provide additional longitudinal and transverse strength. Further, the spacer members 130 also provide a tie for an upper and lower part of the marine beam 101 through which the tubular members 120 do not extend. This prevents the delamination of a top 102 and base 103 of the marine beam from the tubular member. The interconnecting members 140 provide additional transverse strength and also prevents lateral delamination of the tubular members 120 and spacer members 130.

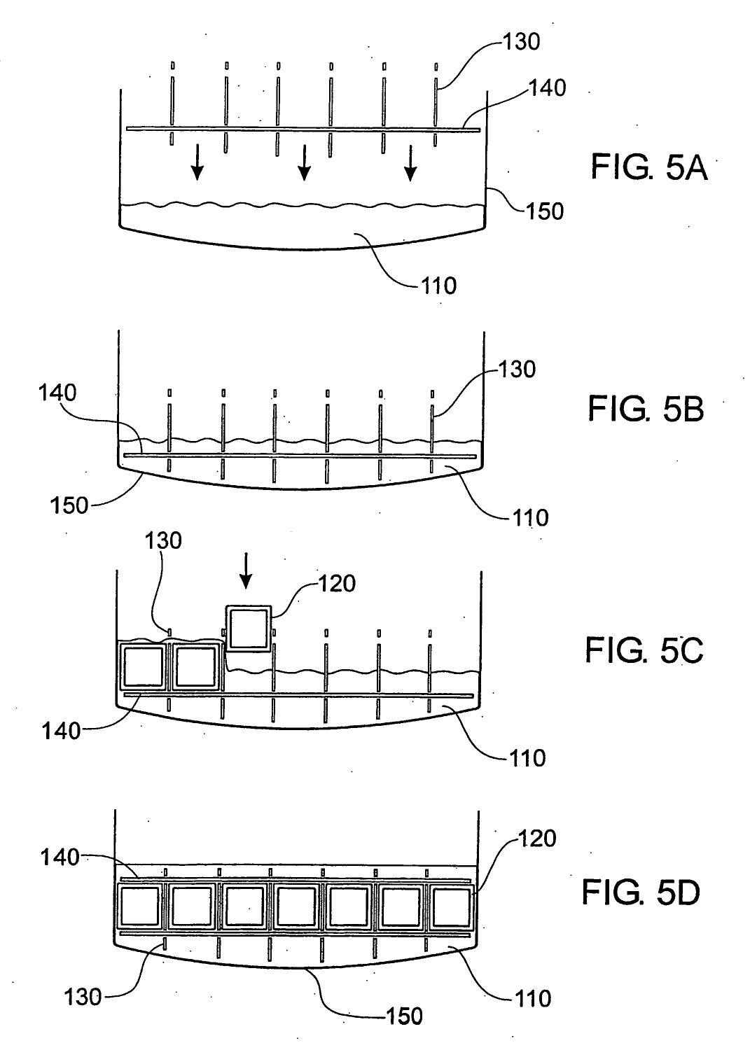

FIGS. 5A to 5D show the process that is used to produce the marine beam 101 shown in FIG. 1. The first step in the process is to produce formwork of a desired shape to produce a mould 150. In this example, the marine beam 101 is produced in an upside down manner.

A level of polymer concrete 110 is then delivered into the mould shown in FIG. 5A. The intersecting spacer members 130 and interconnecting members 140 are then lowered into the polymer concrete 110 as shown in FIG. 5B. Individual tubular members 120 are then located in between respective spacer members 130 causing the polymer concrete 110 to surround the spacer members 130 and tubular members 120 as shown in FIG. 5C. Interconnecting members 140 are then located through the spacer members 130 and additional polymer concrete 110 is added as shown in FIG. 5D. The mould 150 can then be screeded or a top placed onto the mould 150. The polymer concrete 110 is then allowed to cure and the marine beam is removed from the mould 150.

It should be appreciated that the tubular members 120, spacer members 130 and interconnecting members 140 may be formed as shown in

FIG. 2 prior to them being located within the mould. Polymer concrete 110 may be already located within the mould 150 or poured onto the members 120, 130 and 140 to form the marine beam 101 within the mould 150.

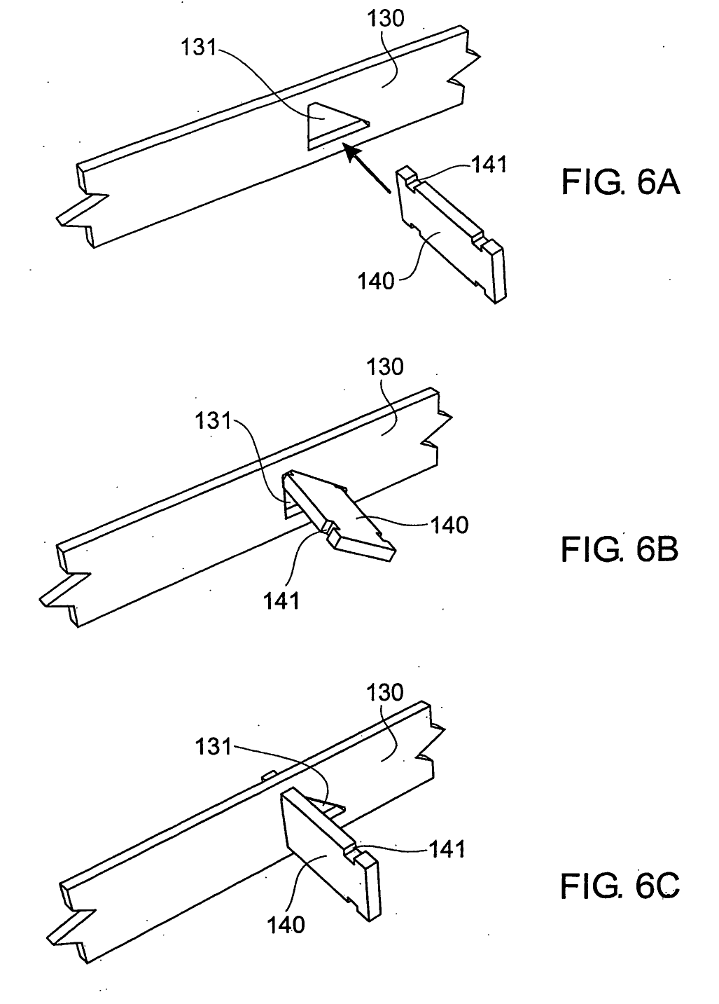

FIGS. 6A to 6C shows a variation on a rectangular slot produced in the spacer member for positioning of the interconnecting member in the marine beam 101 shown in FIGS. 1 to 4. In this embodiment, triangular shaped slots 131 are produced within the spacer members 130. Notches 141 are also produced within the interconnecting members 140. The interconnecting member 140 and spacer member 130 are joined by orienting the intersecting member relative to the triangular slot 131 so that it is inserted adjacent an hypotenuse of the triangular slot 131 as shown in FIG. 6B. The interconnecting member 140 is then rotated when the notch 141 is in alignment with the spacer member. Rotation of the interconnecting member 140 causes the interconnecting member 140 and spacer member 130 to become locked together. This is advantageous as greater tolerances are able to be obtained during the manufacture of structural elements. Further, it also allows for pre-arrangement of the members prior to insertion into a mould.

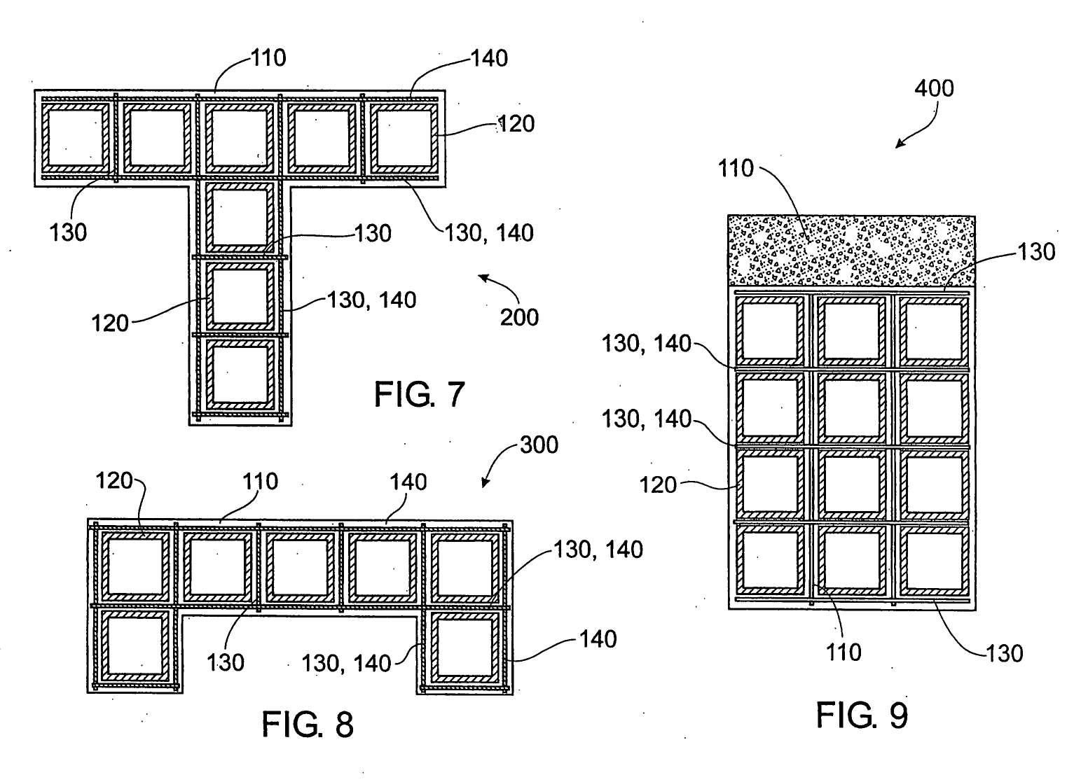

FIGS. 7 and 8 show an example of different structural members 200 and 300 that can be produced using the above method. FIGS. 7 and 8 also disclose that spacer members can be used as interconnecting members and vice versa.

FIG. 9 again shows a variation of a structural element 400. In this structural element tubular members 120 are stacked upon each other with a polymer concrete 110 that has no member located through the polymer concrete 110. This allows for post-forming of the polymer concrete top.

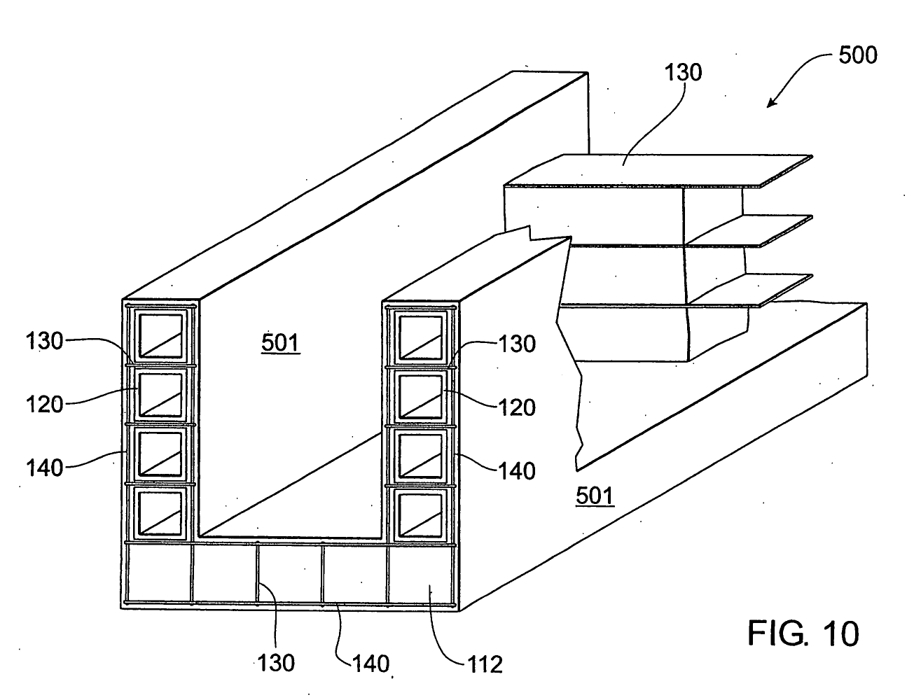

FIG. 10 shows a still further structural element 500 that has a base of polymer concrete 112 that is reinforced with interconnecting members 140 and spacer members 130. The sides 501 of the structural element are formed from tubular members 120, spacer members 130, interconnecting members 140 and polymer concrete 110. Along the length of the beam are intermediate sections 160 of polymer concrete that extend between the sides 501. These are tied in to the structural member using interconnecting members that are located between respective tubular members 120.

The use of the tubular members 120 provides for a lighter structure and also reduces material costs. Another advantage is that the tubular member provides a space for electrical conduits. Still another advantage is that the size of the tubular member can be varied to produce structural elements of different densities.

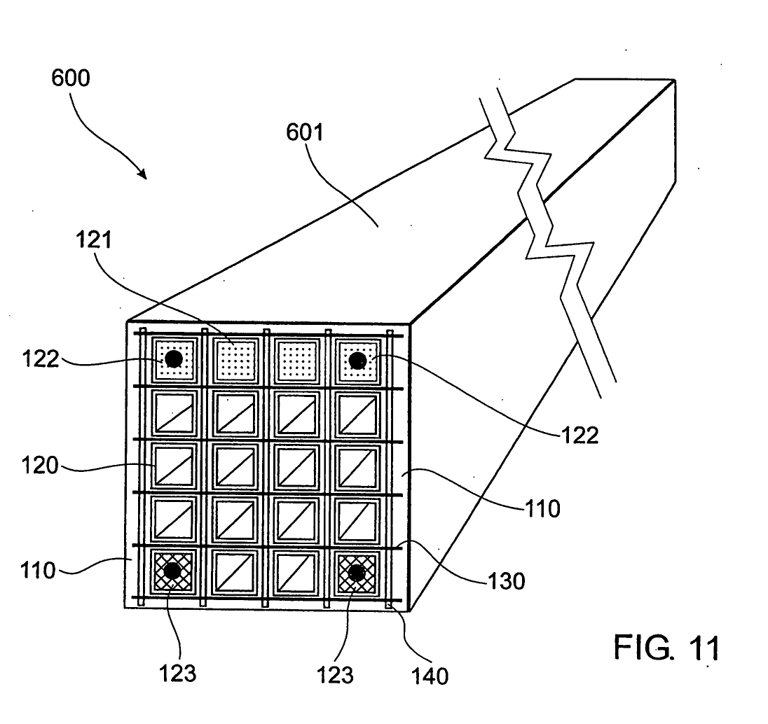

FIG. 11 shows a still further structural element 600 in the form of a beam 601 produced using tubular members 120, interconnecting members 140, and spacer members 130, located within a polymer concrete. Tubular members 151 have been filled with concrete to increase the strength of the tubular members. Tubular members 152 have been filled with concrete and stainless steel reinforcement bars, again to increase the strength of the tubular member. Tubular members 153 have been filled with resin system and fibre reinforced bars to also increase the strength of the tubular members. It should be appreciated that the tubular members can be filled with a variety of materials to change the characteristics of the structural member.

It should be appreciated that various other changes and modifications may be made to the embodiment described without departing from the spirit or the scope of the invention.

1. A structural element formed from castable material, said structural element comprising:
a plurality of fibre reinforced plastic, tubular members;
a plurality of fibre reinforced plastic, spacer members, said spacer members extending between said plurality of tubular members;
a plurality of fibre reinforced plastic, interconnecting members, said interconnecting members positioned in a different orientation to said spacing members; and
castable material surrounding said members;
wherein the interconnecting members and spacer members intersect with each other.

2. The structural element of claim 1 wherein the members are produced from any suitable glass, carbon or aramid fibre and/or plastics.

3. The structural element of claim 1 wherein a surface area of the members that contact the castable material are abraded.

4. The structural elements of claim 1 wherein the members are coated with sand and/or gravel.

5. The structural element of claim 1 wherein the tubular members are pultruded fibre reinforced plastic.

6. The structural element of claim 1 wherein the tubular members are hollow.

7. The structural element of claim 1 wherein the tubular members are filled with standard concrete, polymer concrete or a filled resin system.

8. The structural element of claim 1 wherein the tubular members are filled with standard concrete, polymer concrete or a filled resin system and a metal or fibre composite reinforcing bar.

9. The structural element of claim 1 wherein the spacer members and interconnecting members are constructed from the same fibre reinforced plastic.

10. The structural element of claim 1 wherein the spacer members and interconnecting members have greater strength than transverse strength of the tubular members.

11. The structural element of claim 1 wherein the interconnecting members pass through the spacer members.

12. The structural element of claim 1 wherein the spacer members pass through the interconnecting members.

13. The structural element of claim 1 wherein slots are located one or both of the interconnecting members and/or spacer members.

14. The structural element of claim 13 wherein the interconnecting members and spacer members are locked to each other.

15. The structural element of claim 13 wherein notches are provides in the interconnecting members and/or spacer members to engage with the slot on the other of the interconnecting member or spacer member to lock the interconnecting members and spacer members together.

16. The structural element of claim 1 wherein the interconnecting members are oriented so that they are substantially perpendicular to the spacer members.

17. The structural element of claim 1 wherein the castable material is usually concrete.

18. The structural element of claim 17 wherein the concrete is polymer concrete or a filled resin system.

19. A method of producing a structural element formed from castable material, said method including the steps of:
producing a mould that has a portion of an outer shape of the structural element to be produced;
placing fibre reinforced plastic, tubular members; fibre reinforced plastic, spacer members; and fibre reinforced plastic, interconnecting members; within the mould such that said spacer members extending between said plurality of tubular members and said interconnecting members are positioned in a different orientation to said spacing members; so the spacing members and interconnecting members intersect;
locating castable material between and over said members;
allowing said castable material to set to form said structural element.

20. The method of claim 19 including the additional step of abrading the members prior to the members being introduced into the mould.

21. The method of claim 19 including the additional step of coating the members with sand and/or gravel prior to the members being introduced into the mould.

22. The method of claim 19 wherein the members are located within the mould and castable material poured over the members.

23. The method of claim 19 wherein the members are located within the mould after sufficient castable material to complete the structural element has been delivered into the mould.

24. The method of claim 19 wherein a portion of castable material is introduced into the mould and some of the members introduced into the mould and then more castable material is introduced into the mould and more members are introduced into the mould.
